(19) United States
(12) Patent Application Publication
(10) Pub. No.: US 2016/0031269 A1
(43) Pub. Date: Feb. 4, 2016

(54) PNEUMATIC TIRE

(71) Applicant: TOYO TIRE & RUBBER CO., LTD., Osaka (JP)

(72) Inventor: Kazuhiro Sakakibara, Osaka-shi (JP)

(73) Assignee: TOYO TIRE & RUBBER CO., LTD., Osaka (JP)

(21) Appl. No.: 14/803,368

(22) Filed: Jul. 20, 2015

(30) Foreign Application Priority Data
Aug. 1, 2014 (JP) 2014-157765

(51) Int. Cl. B60C 19/00; B60C 5/00

(52) U.S. Cl. CPC B60C 19/002; B60C 5/00

(57) ABSTRACT

A pneumatic tire includes a plate-like member which is attached to a tread portion inner surface by at least two attaching portions arranged with a space in a tire circumferential direction, and has a space with respect to the tread portion inner surface between the two adjacent attaching portions, wherein a through hole penetrating toward the space is formed in the plate-like member.

### BACKGROUND OF THE INVENTION

1. Field of the Invention

The present invention relates to a pneumatic tire which can reduce cavernous resonance sound by attaching a plate-like member to an inner surface of a tread portion.

2. Description of the Related Art

In the case that a vehicle travels on a rough road surface or climbs over a joint of the road surface, noise that is road noise may be generated in a vehicle. The road noise is one of the noise which has a relation with the tire. In the case that the tire is vibrated by receiving the irregularities of the road surface, the cavernous resonance sound is energized in an inner portion of the tire by the vibration, and the noise in the vehicle is caused.

In Patent Document 1, there is described a pneumatic tire in which a sound control material made of a sponge material is arranged in a tire inner cavity surrounded by a rim and the pneumatic tire, for the purpose of reducing the road noise. However, the sponge material mentioned above is in danger of increasing a whole weight of the tire so as to cause deterioration of fuel consumption. Further, there is a problem of causing an increase of cost since a large number of sponge materials are required.

In Patent Document 2, there is described a pneumatic tire in which a partition wall partitioning an interior of an air chamber in a circumferential direction is provided within the air chamber which is formed between a tire inner peripheral surface and a rim outer peripheral surface, for the purpose of preventing deterioration of the road noise while suppressing a great cost increase. An equivalent length of an air column within the air chamber becomes shorter by using the partition wall to partition the interior of the air chamber in the circumferential direction, so that resonant frequency of air column resonance can be shifted, thereby preventing deterioration of the road noise due to the air column resonance.

Further, in Patent Document 3, there is provided a pneumatic tire in which a thin elastic divider plate extending approximately in an axial direction within a tire inner cavity is provided in an inner wall of the tire, for the purpose of reducing road noise caused by cavernous resonance sound while suppressing an increase in weight. A whole sound pressure mode within the tire inner cavity changes and an in-vehicle noise level is reduced, by the provision of the elastic divider plate within the tire inner cavity.

However, the partition wall and the divider plate vibrate by themselves and may deteriorate the road noise due to the cavernous resonance sound as a new sound source.

### PRIOR ART DOCUMENT

### Patent Document

Patent Document 1: JP-A-2006-306302
Patent Document 2: JP-A-7-117404
Patent Document 3: JP-A-5-294102

### SUMMARY OF THE INVENTION

Consequently, an object of the present invention is to provide a pneumatic tire which can reduce cavernous resonance sound while suppressing an increase in weight and an increase in cost.

The object can be achieved by the following present invention. That is, the present invention provides a pneumatic tire including a plate-like member which is attached to a tread portion inner surface by at least two attaching portions arranged with a space in a tire circumferential direction, and has a space with respect to the tread portion inner surface between the two adjacent attaching portions, wherein a through hole penetrating toward the space is formed in the plate-like member.

In the pneumatic tire according to the present invention, the plate-like member in which the through holes are formed is attached to the inner surface of the tread portion. The plate-like member is attached by two attaching portions which are arranged so as to be spaced in the tire circumferential direction, and has the space with respect to the inner surface of the tread portion between these two attaching portions. More specifically, through holes are formed in the plate-like member which is in a floating state from the inner surface of the tread portion between the attaching portions. Generally, in the case that the sound passes through the through hole, viscous damping is generated by friction between the air and the inner wall surface of the through hole, and pressure loss damping is generated by vortex which is generated by passing. As a result, the sound is damped. Therefore, since the sound within the tire passes through the through holes by attaching to the inner surface of the tread portion the plate-like member in which the through holes are formed, the cavernous resonance sound can be damped and reduced. Further, since it is not necessary to provide a large number of sound absorbing materials and sound control materials made of the sponge material, the increase in weight and the increase in cost can be suppressed.

In the pneumatic tire according to the present invention, a plurality of the plate-like members are preferably arranged at even intervals in the tire circumferential direction.

With this configuration, the provision of a plurality of plate like members enhances the damping effect given by the plate-like member, thereby effectively reducing the cavernous resonance sound. Further, deterioration of uniformity and weight balance can be suppressed by arranging the plate-like members at the uniform intervals in the tire circumferential direction.

In the pneumatic tire according to the present invention, it is preferable that the plate-like member is additionally arranged in the space between the plate-like member and the tread portion inner surface.

With this configuration, the air flowing in the tire diametrical direction and the tire circumferential direction passes through the through holes of a plurality of plate-like members, so that the cavernous resonance sound can be effectively reduced.

In the pneumatic tire according to the present invention, a porous sound absorbing plate is preferably stuck on a plate surface of the plate-like member, and a through hole is formed in the porous sound absorbing plate at a position corresponding to the through hole of the plate-like member.

With this configuration, the air passes through the through holes in the plate-like member and the porous sound absorbing plate, so that the viscous damping effect can be enhanced, thereby effectively reducing the cavernous resonance sound. Further, the sound absorbing effect of the porous sound absorbing plate itself can be obtained, thereby further reducing the cavernous resonance sound.

In the pneumatic tire according to the present invention, the porous sound absorbing plate is preferably stuck on a plate surface facing the space among two plate surfaces of the plate-like member.

With this configuration, the porous sound absorbing plate is provided, facing the space between the plate-like member and the inner surface of the tread portion, so that the sound reflecting within the space can be appropriately absorbed by the porous sound absorbing plate, thereby further reducing the cavernous resonance sound.

### BRIEF DESCRIPTION OF THE DRAWINGS

FIG. 1 is a perspective view showing an example of a pneumatic tire according to the present invention;

FIG. 2A is a cross sectional view in a tire meridian of the pneumatic tire;

FIG. 2B is a cross sectional view in a tire circumferential direction of the pneumatic tire;

FIG. 3 is an enlarge cross sectional view showing a plate-like member in an enlarged manner;

FIG. 4 is a plan view of the plate-like member;

FIG. 5 is a cross sectional view in a tire circumferential direction of a pneumatic tire according to the other embodiment;

FIG. 6 is a front elevational view of a pneumatic tire according to the other embodiment;

FIG. 7 is a front elevational view of a pneumatic tire according to the other embodiment;

FIG. 8 is a cross sectional view in a tire circumferential direction of a pneumatic tire according to the other embodiment;

FIG. 9 is a cross sectional view in a tire circumferential direction of a pneumatic tire according to the other embodiment;

FIG. 10 is a front elevational view of a pneumatic tire according to the other embodiment; and

FIG. 11 is a front elevational view of a pneumatic tire according to the other embodiment.

### DETAILED DESCRIPTION OF THE PREFERRED EMBODIMENTS

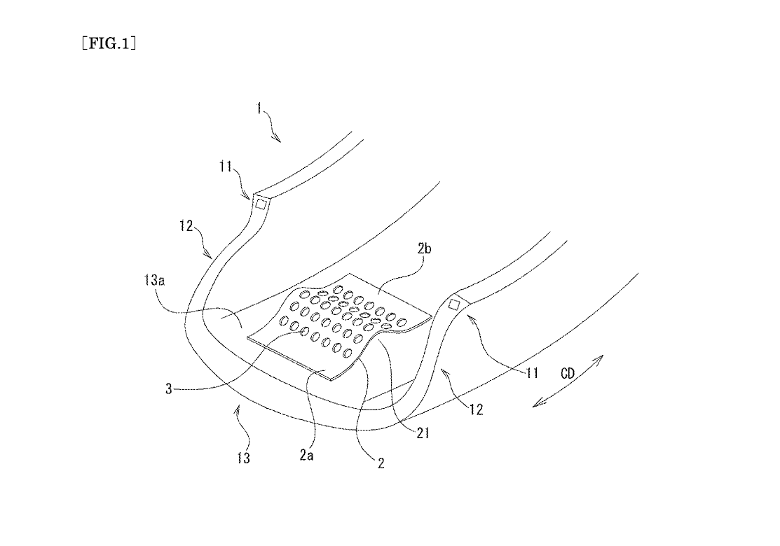

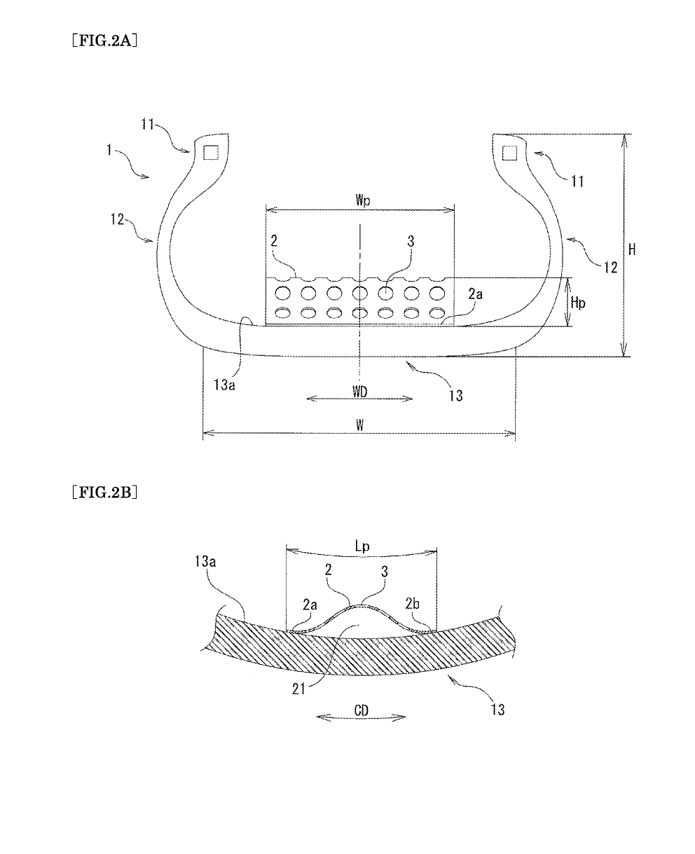

A description will be given below of embodiments according to the present invention with reference to the accompanying drawings. FIG. 1 is a perspective view showing an example of a pneumatic tire. FIG. 2A is an example of a cross sectional view in a tire meridian of the pneumatic tire. FIG. 2B is an example of a cross sectional view in a tire circumferential direction of the pneumatic tire. Here, reference symbol H denotes a tire cross sectional height. The tire cross sectional height H is a height from a nominal rim diameter to a tread surface in a state of being filled with an air pressure in JATMA regulation, in the tire meridian cross section.

As shown in FIGS. 1 and 2A, a pneumatic tire 1 is provided with a pair of annular bead portions 11, side wall portions 12 each of which extends to an outer side in a tire diametrical direction from each of the bead portions 11, and a tread portion 13 which is connected to an outer end in the tire diametrical direction of each of the side wall portions 12.

The pneumatic tire 1 is provided with a plate-like member 2 which is attached to a tread portion inner surface 13a. The plate-like member 2 is attached to the tread portion inner surface 13a by two attaching portions 2a and 2b which are arranged so as to be spaced in a tire circumferential direction CD. The plate-like member 2 is curved so as to protrude toward an interior in the tire diametrical direction between two attaching portions 2a and 2b, and has a space 21 with respect to the tread portion inner surface 13a between two adjacent attaching portions 2a and 2b.

In the present embodiment, the attaching portions 2a and 2b are arranged respectively in both ends of the plate-like member 2; however, the attaching portions 2a and 2b are not necessarily arranged in both ends of the plate-like member 2. Further, as long as at least two attaching portions are arranged in one plate-like member 2, three or more attaching portions may be arranged.

Through holes 3 penetrating toward a space 21 are formed in the plate-like member 2. Only one through hole 3 may be formed, however, it is preferable that a plurality of through holes 3 are formed as in the present embodiment. A penetrating direction of the through holes 3 is not necessarily vertical to a plate surface of the plate-like member 2, but may be set to any direction in which the through holes 3 penetrate from an outer portion to an inner portion of the space 21.

A description will be given of an effect of damping cavernous resonance sound by the through holes 3. When the sound passes through the through hole 3, the cavernous resonance sound is damped by friction between the air serving as a medium and an inner wall surface of the through hole 3 (a viscous damping). Further, when the sound passes through the through hole 3, vortex is generated by the passage of the sound to generate pressure loss, thereby damping the cavernous resonance sound (pressure loss damping). As a result, since the sound within the tire passes through the through holes 3 by attaching to the tread portion inner surface 13a the plate-like member 2 in which the through holes 3 are formed, the cavernous resonance sound can be damped and reduced.

Further, the viscous damping and the pressure loss damping when the sound passes through the through holes 3 have a relation with a particle velocity of the air. As the through holes 3 are arranged at a place where particle velocity is large, the cavernous resonance sound is effectively damped. Further, since the air flow is added to the velocity, the through holes 3 are preferably arranged at a place where the air flow exists.

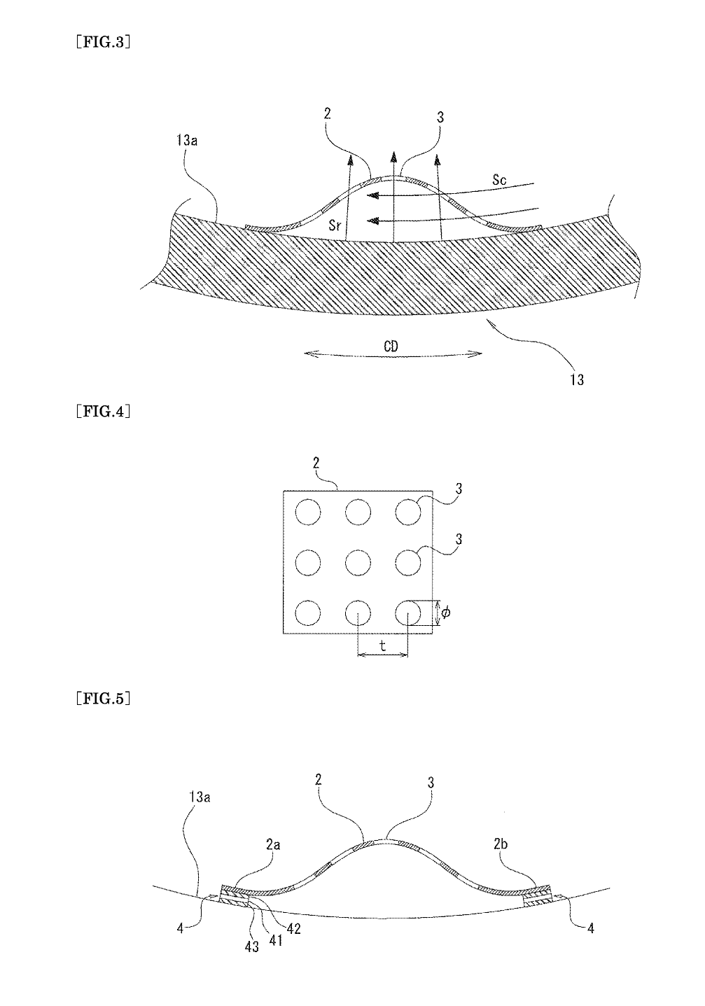

FIG. 3 is an enlarged cross sectional view showing the plate-like member 2 in which the through holes 3 are formed, in an enlarged manner. The air flow within the tire is denoted by arrows. The air flow Sr and the air flow Sc in a tire circumferential direction CD exist within the tire, in which the air flow Sr is generated by deformation of the tire on the basis of grounding with a road surface, and the air flow Sc is generated by restoration of the deformation. Since the sound generated by the input from the road surface and the air flow Sr in the tire diametrical direction pass through the through holes 3 by arranging the plate-like member 2 so as to cover the tread portion inner surface 13a, the cavernous resonance sound can be effectively reduced. Further, since the sound transmitted in the tire circumferential direction CD and the air flow Sc in the tire circumferential direction CD pass through the through holes 3 by attaching the plate-like member 2 so as to protrude toward an interior in the tire diametrical direction, the cavernous resonance sound can be effectively reduced.

Further, the closer to the tread portion inner surface 13a the air flow is, the faster the air flow is. As a result, in the present invention, the plate-like member 2 in which the through holes 3 are formed is attached to the tread portion inner surface 13a.

The thickness of the plate-like member 2 is preferably between 0.1 and 10 mm, and more preferably between 0.5 and 2 mm. If the thickness of the plate-like member 2 is made thinner than 0.1 mm, the effect of reducing the cavernous resonance sound by the plate-like member 2 becomes smaller. On the other hand, if the thickness of the plate-like member 2 is made thicker than 10 mm, the tread portion inner surface 13a is locally increased in weight by the plate-like member 2. Thus, a high-speed uniformity tends to be deteriorated, and vibration and riding quality caused by the deterioration tend to be deteriorated.

The maximum height Hp from the tread portion inner surface 13a in the tire equator of the plate-like member 2 is preferably equal to or more than tenth part of the tire cross sectional height H (or 10 mm). If the maximum height Hp of the plate-like member 2 is made lower than tenth part of the tire cross sectional height H, an effect of reducing the cavernous resonance sound by the plate-like member 2 becomes smaller. On the other hand, the maximum height Hp of the plate-like member 2 is preferably equal to or less than half of the tire cross sectional height H. If the maximum height Hp of the plate-like member 2 is made higher than half of the tire cross sectional height H, the plate-like member 2 comes into contact with the rim flange when assembling the rim, which may cause a failure.

A width Wp in a tire width direction WD of the plate-like member 2 is preferably between 30 and 120% of a grounding width W. If the width Wp of the plate-like member 2 is made narrower than 30% of the grounding width W, the effect of reducing the cavernous resonance sound becomes smaller. On the other hand, if the width Wp of the plate-like member 2 is made wider than 120% of the grounding width W, the plate-like member 2 may come into contact with the inner surface of the side wall and the following property to the curved surface may be deteriorated due to deformation at the grounding time, which may cause a failure.

A length Lp in the tire circumferential direction of the plate-like member 2 is preferably equal to or less than half of the grounding length and more preferably equal to or less than third part thereof. The length Lp in the tire circumferential direction of the plate-like member 2 is preferably set to a size which can divide the grounding length into two or more parts for covering the grounding part in the step-in and the kick-out.

FIG. 4 is a plan view showing a state in which a part of the plate-like member 2 is extended in a planar manner. A hole diameter φ of the through hole 3 is preferably between 0.4 and 10 mm, and more preferably between 1 and 3 mm. If the hole diameter φ is smaller than 0.4 mm, the resistance becomes too larger when the sound and the air pass through the hole, thereby failing to be effective, and being hard to be manufactured. On the other hand, if the hole diameter φ is larger than 10 mm, the resistance becomes too small when the sound and the air passes through the hole, and the damping effect becomes smaller.

Further, a rate of hole area P is preferably between 1 and 20%, and more preferably between 1 and 10%. If the rate of hole area P is smaller than 1%, the resistance becomes too large when the sound and the air passes through the hole, thereby failing to be effective. On the other hand, if the rate of hole area P is larger than 20%, the resistance becomes too small when the sound and the air passes through the hole, and the damping effect becomes smaller. On the assumption that a hole distance between the through holes 3 is t, the rate of hole area P in the case that a plurality of through holes 3 are vertical and horizontally arranged in parallel with each other like in the present embodiment is defined by equation P=(π×φ²)/(4×t²). For example, on the assumption that the hole diameter φ is 3 mm, and the hole distance t is 10 mm, the rate of hole area P is about 7%.

The hole distance t between the through holes 3 is appropriately set by the rate of hole area P and the hole diameter φ by using the equation mentioned above. However, for example, the hole distance t is preferably between 1 and 30 mm, and more preferably between 5 and 15 mm. If the hole distance t is smaller than 1 mm, the number of holes becomes necessarily larger, the resistance becomes too small when the sound and the air pass through the hole, and the damping effect becomes smaller. Further, a strength of the plate itself is deteriorated. On the other hand, if the hole distance t is larger than 30 mm, the number of holes becomes necessarily smaller, and the obtained damping effect becomes smaller.

The plate-like member 2 is formed by a plate-like or film-like resin. A general-purpose resin such as PET, PU, TPU, PVC, PC, PE or PEN can be exemplified as the resin.

The plate-like member 2 is attached to the tread portion inner surface 13a by the attaching portions 2a and 2b. The plate-like member 2 is fixed to the tread portion inner surface 13a by an adhesive agent or a double-faced tape. At this time, as shown in FIG. 5, the plate-like member 2 is preferably fixed to the tread portion inner surface 13a via a cushion layer 4. The cushion layer 4 is constructed by a cushion layer main body 41 having retractility, and adhesive agent layers 42 and 43 in both sides of the cushion layer main body 41. As a result, since the cushion layer main body 41 in the cushion layer 4 deforms and can follow the shape of the curved surface of the tread portion inner surface 13a and the deformation at the grounding time, the plate-like member 2 can be stably fixed to the tread portion inner surface 13a.

A weight of the plate-like member 2 is preferably equal to or less than 15 g, and more preferably equal to or less than 10 g. The weight of the plate-like member 2 causes a local weight increase of the tread portion inner surface 13a, a high-speed uniformity tends to be deteriorated, and vibration and riding quality caused by the deterioration tend to be deteriorated. In the case that the cushion layer 4 is provided, the total weight including the plate-like member 2 and the cushion layer 4 is preferably made equal to or less than 20 g, and more preferably equal to or less than 15 g.

### Other Embodiments

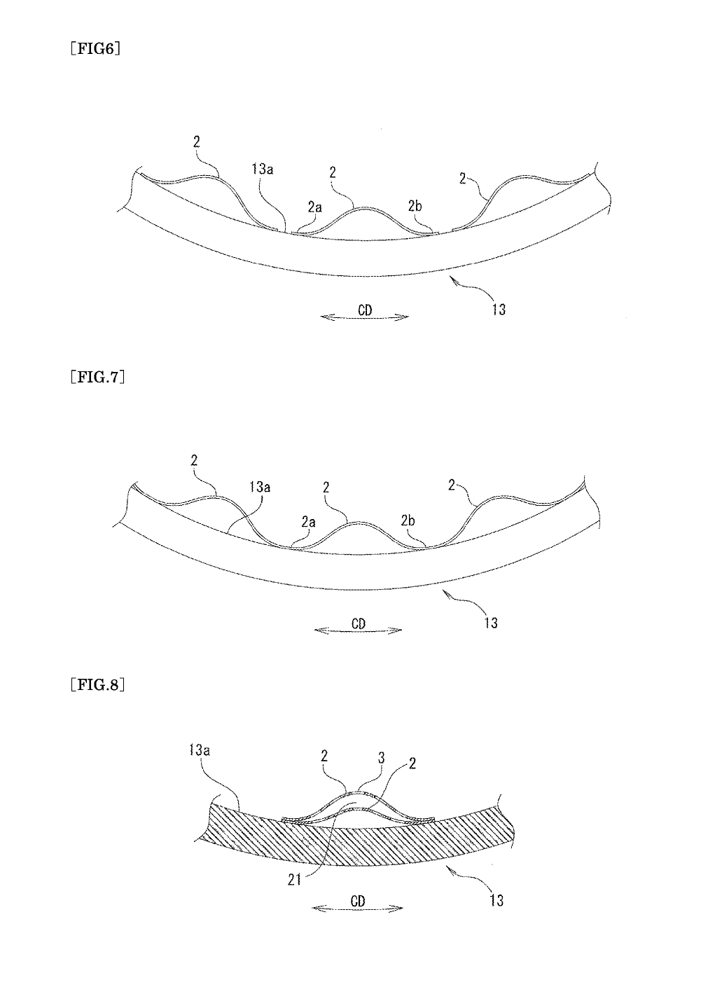

(1) In the present invention, the pneumatic tire 1 is preferably provided with a plurality of plate-like members 2, and a plurality of plate-like members 2 are preferably arranged at even intervals in the tire circumferential direction CD, as shown in FIG. 6. Further, a plurality of plate-like members 2 can be arranged so as to connect the adjacent plate-like members 2 to each other as shown in FIG. 7.

(2) In the present invention, the additional plate-like member 2 is preferably arranged in a space 21 between the plate-like member 2 and the tread portion inner surface 13a, as shown in FIG. 8. As a result, the air flowing in the tire diametrical direction and the tire circumferential direction passes through the through holes 3 of a plurality of plate-like members 2, so that the cavernous resonance sound can be effectively reduced. The plate-like member 2 may be arranged in a two-ply manner like FIG. 8, or may be arranged in a three or more-ply manner.

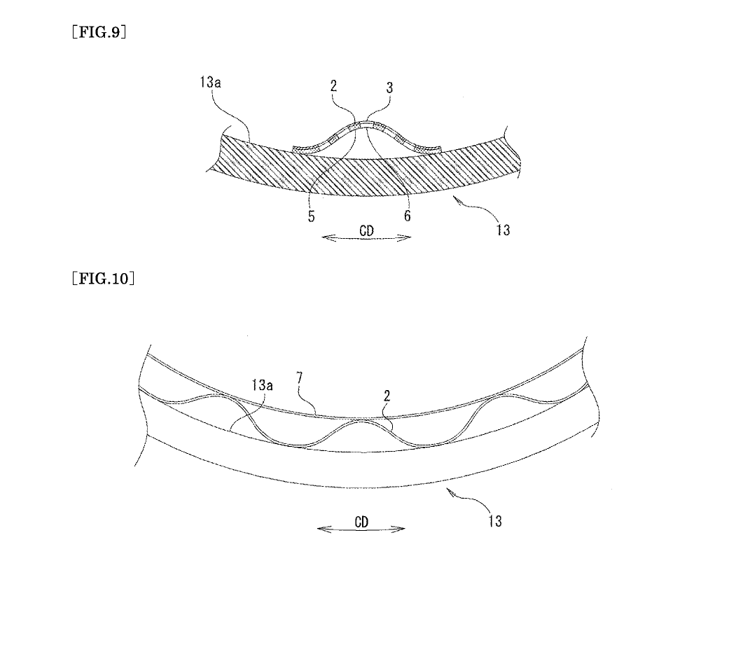

(3) In the present invention, a porous sound absorbing plate 5 is preferably stuck on a plate surface of the plate-like member 2 and a through hole 6 is preferably formed at a position corresponding to the through hole 3 in the porous sound absorbing plate 5, as shown in FIG. 9. The porous sound absorbing plate 5 may be stuck on at least one plate surface of the plate-like member 2, however, may be stuck on both the plate surfaces of the plate-like member 2. Further, the porous sound absorbing plate 5 is particularly preferably stuck on the plate surface facing the space 21 among two plate surfaces of the plate-like member 2. Further, the plate-like member 2 on which the porous sound absorbing plate 5 is stuck like FIG. 9 may be arranged in a plurality of piles like FIG. 8. A material of the porous sound absorbing plate 5 is not particularly limited; however, a sponge constructed by a soft polyurethane foam is preferably employed. The material of the porous sound absorbing plate 5 is not limited to the soft polyurethane foam as long as the material has the sound absorbing effect, and a fiber material such as a glass wool and an unwoven fabric may be employed. A thickness of the porous sound absorbing plate 5 is preferably between 3 and 15 mm.

(4) A porous plate 7 in which through holes are formed may be arranged in an interior in the tire diametrical direction of the plate-like member 2, as shown in FIG. 10. The through holes are formed in the porous plate 7, and the porous plate 7 has an effect of reducing the cavernous resonance sound in the same manner as the plate-like member 2, so that the cavernous resonance sound can be further reduced.

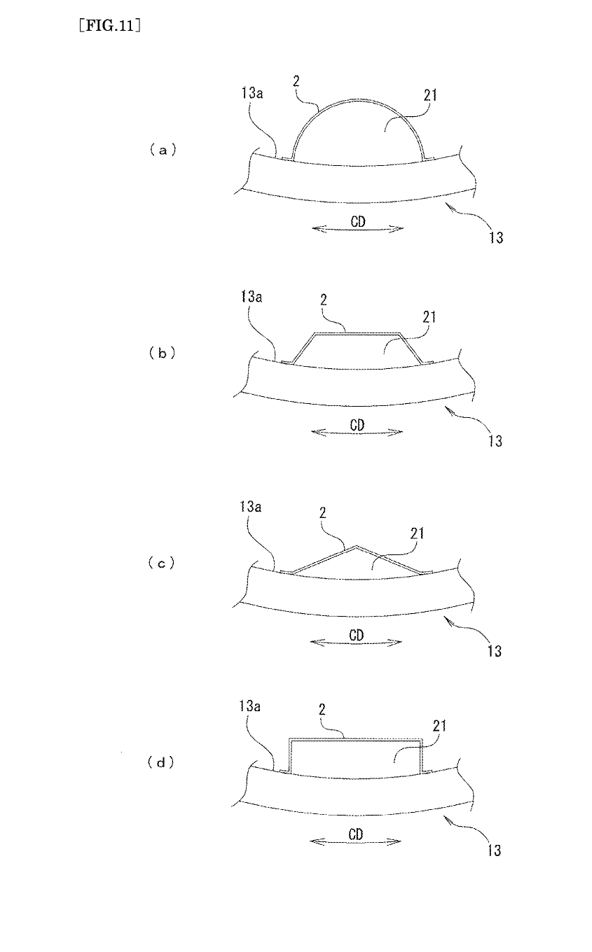

(5) In the embodiment mentioned above, the plate-like member 2 is formed into a curved shape so as to protrude toward the interior in the tire diametrical direction between two attaching portions 2a and 2b. FIG. 11 shows side elevational views of the plate-like members 2 according to the other embodiments. As shown in FIG. 11, the plate-like member 2 may be curved or bent, and has a shape that is not limited particularly as long as the plate-like member 2 is formed into a shape which has the space 21 with respect to the tread portion inner surface 13a between two adjacent attaching portions 2a and 2b.

### EXAMPLES

A description will be given below of examples which specifically show the structure and the effect of the present invention. Items to be evaluated in the examples were measured as follows.

### Noise Measurement

A pneumatic tire having a tire size 195/65R15 was attached to an actual car and a sound pressure level (dB) was measured in a driver seat when traveling on an uneven road surface at 60 km/h. The evaluation is denoted by an index number on the assumption that a comparative example 1 is 100, and the smaller numerical value indicates the smaller cavernous resonance sound. Results of evaluation are shown in Table 1.

### Comparative Example 1

A structure in which the plate-like member is not provided in the tread portion inner surface was set to the comparative example 1.

### Comparative Example 2

A structure in which the plate-like member having no through hole is attached to the tread portion inner surface was set to a comparative example 2. The plate-like member in which a thickness is 0.1 mm, a width is 80 mm and a length is 120 mm was attached so that the maximum height is 35 mm, and the length in the tire circumferential direction is 80 mm. The plate-like members according to the other examples were formed into the same shape.

### Example 1

A structure in which the through holes are formed in the plate-like member according to the comparative example 2 was set to an example 1. The through holes were structured such that a hole diameter is 1 mm, the number of the holes is 6×6 and a hole distance is 13 mm.

### Example 2

A structure in which the through holes are formed in the plate-like member according to the comparative example 2 was set to an example 2. The through holes were structured such that a hole diameter is 3 mm, the number of the holes is 8×8 and a hole distance is 10 mm.

### Example 3

A structure in which two plate-like members according to the example 2 are laminated as shown in FIG. 8 was set to an example 3.

### Example 4

A structure in which the porous sound absorbing plate is stuck on a plate surface in an opposite side to the space (a plate surface in an outer side of the space) among two plate surfaces of the plate-like member according to the example 3 was set to an example 4. The porous sound absorbing plate is structured such that a thickness is 3 mm, and a width and a length are the same as those of the plate-like member.

### Example 5

A structure in which the porous sound absorbing plate is stuck on a plate surface facing the space (a plate surface in an interior of the space) among two plate surfaces of the plate-like member according to the example 3 was set to an example 5. The porous sound absorbing plate is structured such that a thickness is 3 mm, and a width and a length are the same as those of the plate-like member.

TABLE 1

| | Comparative | Comparative | | | | | |
|---|---|---|---|---|---|---|---|
| | Example 1 | Example 2 | Example 1 | Example 2 | Example 3 | Example 4 | Example 5 |
| Plate-like | Without | One sheet | One sheet | One sheet | Two sheets | Two sheets | Two sheets |
| member | | | | | | | |
| Through hole | — | Without | With | With | With | With | With |
| Porous sound | — | Without | Without | Without | Without | With | With |
| absorbing | | | | | | (out of | (within |
| plate | | | | | | space) | space) |
| Noise | 100 | 100 | 90 | 78 | 75 | 67 | 62 |

The following matters can be known from the results in Table 1. The pneumatic tires according to the examples 1 to 5 could reduce the cavernous resonance sound in comparison with the comparative example 1. In the pneumatic tire according to the comparative example 2, the through hole is not provided in the plate-like member, so that the cavernous resonance sound was not reduced.

### DESCRIPTION OF REFERENCE NUMERALS

1 pneumatic tire
2 plate-like member
2a attaching portion
2b attaching portion
3 through hole
5 porous sound absorbing plate
21 space
CD tire circumferential direction

What is claimed is:

1. A pneumatic tire comprising a plate-like member which is attached to a tread portion inner surface by at least two attaching portions arranged with a space in a tire circumferential direction, and has a space with respect to the tread portion inner surface between the two adjacent attaching portions,
wherein a through hole penetrating toward the space is formed in the plate-like member.

2. The pneumatic tire according to claim 1, wherein a plurality of the plate-like members are arranged at even intervals in the tire circumferential direction.

3. The pneumatic tire according to claim 1, wherein the plate-like member is additionally arranged in the space between the plate-like member and the tread portion inner surface.

4. The pneumatic tire according to claim 1, wherein a porous sound absorbing plate is stuck on a plate surface of the plate-like member, and a through hole is formed in the porous sound absorbing plate at a position corresponding to the through hole of the plate-like member.

5. The pneumatic tire according to claim 4, wherein the porous sound absorbing plate is stuck on a plate surface facing the space among two plate surfaces of the plate-like member.
